(19) United States
(12) Patent Application Publication
(10) Pub. No.: US 2021/0182772 A1
(43) Pub. Date: Jun. 17, 2021

(54) SYSTEM AND METHOD FOR ORDER CONSOLIDATION

(71) Applicant: GREY ORANGE PTE. LTD., Singapore (SG)

(72) Inventor: Kalpesh JESWANI, Nagpur (IN)

(73) Assignee: GREY ORANGE PTE. LTD., Singapore (SG)

(21) Appl. No.: 16/712,773

(22) Filed: Dec. 12, 2019

(51) Int. Cl. G06Q 10/08

(52) U.S. Cl. CPC G06Q 10/087

(57) ABSTRACT

An order consolidation system includes an operation station including a plurality of bins, an identification mechanism, a conveying mechanism, and control circuitry. The control circuitry selects a set of master packages of an item for fulfilling a set of order lines for the item. The control circuitry identifies one or more master packages from the set of master packages that are to be split at unit level. The one or more master packages are conveyed by the conveying mechanism to a first bin that is selected as segregation bin by the identification mechanism for splitting into individual units and segregating into batches. Remaining packages, of the set of master packages, and the batches are conveyed by the conveying mechanism to a second bin that is selected as consolidation bin by the identification mechanism for consolidating into one or more order line packages for fulfilling the set of order lines.

### FIELD OF THE INVENTION

The present disclosure relates generally to order fulfilment, and more particularly, to a system and a method for sorting and consolidating items in a facility for order fulfilment.

### BACKGROUND

Modern storage facilities or warehouses handle a large number of items on a daily basis. These storage facilities or warehouses may receive and store packages of various items. Items stored in these packages are sorted and consolidated for fulfilment of order requests. Typically, sortation systems and consolidation systems are employed within the storage facilities or warehouses for the sortation and the consolidation of the items.

Fulfilment of the order requests typically involves feeding required number of pertinent items to a sortation system for sortation. Thus, various packages of the items are broken down into their constituent items or units for feeding to the sortation system. Conventional sortation systems rely on manual intervention by a warehouse manager to decide upon a count of packages to be split or broken down as per the order quantity. Manual intervention, however, is time-consuming and fails to accurately predict a required number of packages to split. Splitting every package into its constituent elements before sortation and consolidation is a man-power intensive and time-consuming process, and such sub-optimal solutions may have negative ramifications on efficiency and throughput of a facility. Further, manual decision making has limited applicability in a large-scale facility that aims to fulfil a large number of orders within a short duration of time.

Typically, sortation and consolidation systems have been disjointed systems that feature segregated locations or stations for various operations. For example, a first location or station may serve as a splitting station for splitting packages into individual constituent items and a second station or location may serve as a consolidation station for consolidating individual items or packages for delivery. Such a system that relies upon designated stations for different operations may not scale well enough to facilitate optimal efficiency when a large number of order requests are received. Also, such a system that features multiple such designated stations may require a large physical footprint (i.e., space) in a warehouse, resulting in poor utilization of space.

In light of the foregoing, there exists a need for a technical solution improves throughput and efficiency and reduces a physical footprint of the sortation systems at warehouses and storage facilities.

### SUMMARY

In an embodiment of the present disclosure, an order consolidation method is provided. The method includes receiving, by a control circuitry of an order consolidation system, a plurality of order requests. Each order request includes one or more order lines for one or more items, respectively. A set of order lines for a first item is identified by the control circuitry based on the plurality of order requests. A set of master packages of the first item is selected by the control circuitry for fulfilling the set of order lines. Each of the set of order lines is indicative of an order quantity for the first item. The set of master packages is selected based on a cumulative order quantity of the set of order lines and a count of units of the first item included in each master package of the first item. One or more master packages of the set of master packages, which are to be split at unit level to fulfil the set of order lines, are identified by the control circuitry. A first bin of an operation station of the order consolidation system is selected as a segregation bin and a second bin of the operation station is selected a consolidation bin, by an identification mechanism of the order consolidation system. A conveying mechanism of the order consolidation system is controlled by the control circuitry to convey the one or more master packages from the identification mechanism to the first bin and remaining master packages of the set of master packages from the identification mechanism to the second bin. At the first bin, the one or more master packages are split at unit level to obtain a plurality of units of the first item. The plurality of units are segregated to obtain one or more batches of the first item for one or more order lines of the set of order lines. The conveying mechanism is further controlled by the control circuitry to convey the one or more batches to the second bin. A handler at the collection station is instructed by the control circuitry to consolidate the one or more batches and the remaining master packages received at the second bin based on the order quantity of each of the set of order lines, to obtain a set of order line packages for fulfilling the set of order lines.

In another embodiment of the present disclosure, an order consolidation system is provided. The order consolidation system includes at least one operation station including a plurality of bins, an identification mechanism configured to select a first bin of the plurality of bins as a segregation bin and a second bin of the plurality of bins as a consolidation bin, a conveying mechanism, and a control circuitry. The control circuitry is configured to receive a plurality of order requests. Each order request includes one or more order lines for one or more items, respectively. The control circuitry identifies a set of order lines for a first item based on the plurality of order requests. The control circuitry selects a set of master packages of the first item for fulfilling the set of order lines. The set of master packages is selected based on a cumulative order quantity of the set of order lines and a count of units included in each master package of the first item. The control circuitry identifies one or more master packages of the set of master packages that are to be split at unit level to fulfil the set of order lines. The control circuitry controls the conveying mechanism to convey the one or more master packages from the identification mechanism to the first bin and remaining master packages of the set of master packages from the identification mechanism to the second bin. At the first bin, the one or more master packages are split at unit level to obtain a plurality of units of the first item. The plurality of units are segregated to obtain one or more batches of the first item for one or more order lines of the set of order lines. The control circuitry further controls the conveying mechanism to convey the one or more batches to the second bin. The control circuitry instructs a handler at the second bin to consolidate the one or more batches and the remaining master packages received at the second bin based on the order quantity of each of the set of order lines, to obtain a set of set of order line packages for fulfilling the set of order lines.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an exemplary environment, in accordance with an exemplary embodiment of the present disclosure;

FIG. 2 is a block diagram that illustrates an order consolidation system of FIG. 1, in accordance with an exemplary embodiment of the present disclosure.

FIGS. 3A-3E, represent schematic diagrams that illustrate an exemplary scenario for order consolidation by the order consolidation system, in accordance with an exemplary embodiment of the present disclosure;

FIG. 4 represents a schematic diagram that illustrates the order consolidation system, in accordance with another exemplary embodiment of the present disclosure;

FIG. 5 represents a schematic diagram that illustrates the order consolidation system, in accordance with another exemplary embodiment of the present disclosure;

FIG. 6 is a block diagram that illustrates control circuitry of FIG. 2, in accordance with an exemplary embodiment of the present disclosure; and

FIGS. 7A and 7B, collectively represent a flow chart that illustrates a process for order consolidation by the order consolidation system, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the present disclosure provide a method and a system for order consolidation. An order consolidation system includes at least one operation station including a plurality of bins, an identification mechanism, a conveying mechanism, and a control circuitry. The control circuitry may receive a set of order requests. Each order request may include one or more order lines for one or more items, respectively. Each order line may correspond to a single item and indicate an order quantity for the item. For fulfilling a set of order lines corresponding to a first item, the control circuitry may select a set of master packages of the first item based on a cumulative order quantity of the set of order lines and a count of units included in each of the selected set of master packages of the first item. The set of master packages may be selected such that a difference between the count of units included in the set of master packages and the cumulative order quantity is less than a count of units included in each master package of the first item.

Based on the selection of the set of master packages, the control circuitry may identify one or more master packages, of the set of master packages, to be split at a unit level for the fulfilment of the set of order lines. The one or more packages may be identified based on the order quantity of each of the set of order lines and the count of units in each of the set of master packages, such that a number of master packages to be split at the unit level is minimum for the set of order lines. The identification mechanism may select a first bin of the operation station as a segregation bin and a second bin of the operation station as a consolidation bin. The first bin may be selected as the segregation bin for splitting the one or more master packages at unit level.

The control circuitry may control the conveying mechanism for conveying the one or more packages to the first bin and remaining master packages of the set of master packages to the second bin. At the first bin, the one or more master packages are split at unit level to obtain a plurality of units of the first item and the plurality of units are then segregated to obtain one or more batches of the first item for one or more order lines of the set of order lines. The one or more batches may again be fed to the identification mechanism. The control circuitry may control the conveying mechanism to convey the one or more batches to the second bin. The control circuitry may further instruct a handler at the second bin to consolidate the one or more batches and the remaining master packages into a set of order line packages for fulfilment of the set of order lines. Thus, the method and system of the present disclosure achieve efficient sortation and consolidation of packages and/or items for fulfilment of order requests.

In some embodiments, “Order request” is a request for ordering a set of items from a facility (e.g., a warehouse). The order request may include a set of order lines for the set of items, respectively. Each order line corresponds to a single item and indicates an order quantity of the item. For example, a first order request may include first and second order lines for first and second items, respectively. The first order line corresponding to the first item is indicative of ‘20’ units of the first item and the second order line corresponding to the second item is indicative of ‘10’ units of the second item.

In some embodiments, “Master Package” may be a container, a carton, or a packed box that holds a plurality of units of an item. For example, a master package of soap may hold ‘20’ units of the soap.

In some embodiments, “Conveying Mechanism” is a collection of transportation vehicles and/or mechanical arrangements (e.g., conveyor belts) that facilitate movement of goods (i.e., items, batches, or packages) between various locations in a facility.

In some embodiments, “Batch” is a collection of one or more units of an item or multiple items. Batches of an item may be formed by segregating individual units of an item for fulfilment of order requests. A count of units of an item included in a batch is less than a count of units of the item included in a master package of the item.

In some embodiments, “Server” is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. In one example, the server may be a warehouse management server.

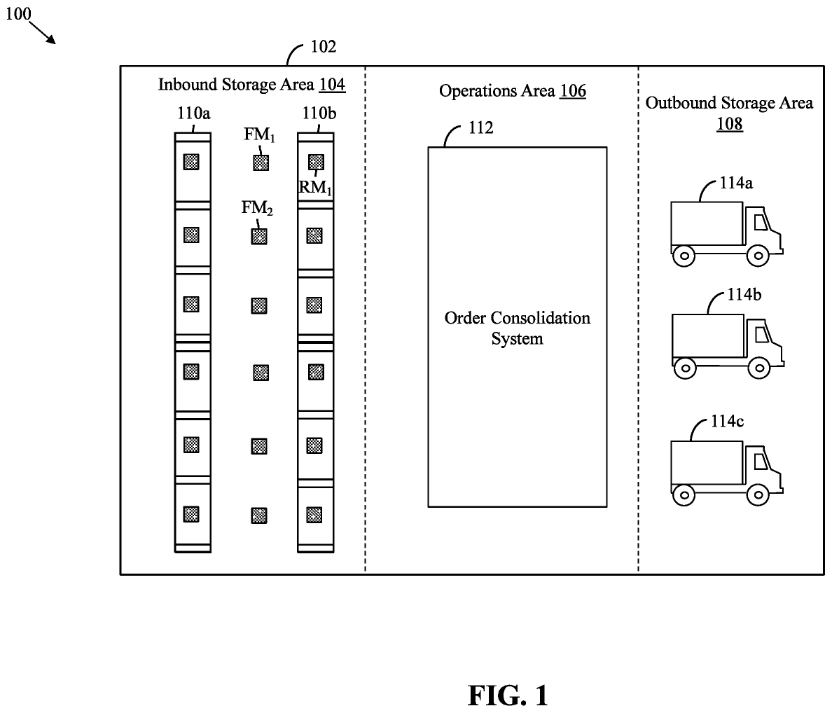

FIG. 1 is a block diagram that illustrates an exemplary environment 100, in accordance with an exemplary embodiment of the present disclosure. The environment 100 shows a facility 102.

The facility 102 may store inventory items or packages of inventory items (i.e., master packages) for order fulfillment and/or selling. Examples of the facility 102 may include, but are not limited to, a forward warehouse, a backward warehouse, an order fulfilment center, or a retail store (e.g., a supermarket, an apparel store, a departmental store, a grocery store, or the like). Examples of the inventory items may include, but are not limited to, groceries, apparels, electronic goods, mechanical goods, or the like. Hereinafter, the terms “inventory items” and “items” are used interchangeably. The facility 102 may be partitioned into various areas or zones based on the operations performed in the areas. For example, the facility 102 may be partitioned to include an inbound storage area 104, an operations area 106, and an outbound storage area 108.

The inbound storage area 104 may store the inventory items that are packed into master packages. Each master package may be a container, a carton, or a packed box that includes multiple units of a single inventory item. For example, a first master package may include 20 units of a first item (e.g., a shampoo bottle). Similarly, another master package may include 40 units of a second item (e.g., a toy). The inbound storage area 104 may include a plurality of inventory storage units (ISUs) for storing the master packages of the inventory items. The inbound storage area 104 may be of any shape, for example, a rectangular shape. For the sake of brevity, only first and second ISUs 110a and 110b (hereinafter, collectively referred to as ‘the ISUs 110’) are shown. In one embodiment, the ISUs 110 in the inbound storage area 104 may be arranged to form aisles therebetween. Arrangement of the ISUs 110 in the inbound storage area 104 is a standard practice and will be apparent to those of skill in the art.

The inbound storage area 104 may further include a plurality of fiducial markers (e.g., floor markers or ISU markers). Floor markers such as first and second floor markers FM₁ and FM₂ may be utilized by various transportation vehicles to navigate the inbound storage area 104. ISU markers such as an ISU marker RM₁ may be indicative of a corresponding ISU (e.g., the second ISU 110b). The first and second floor markers FM₁ and FM₂ may be affixed to a floor surface of the facility 102 to facilitate the navigation by the transportation vehicles. In goods-to-person implementation, the transportation vehicles may transport the ISUs 110 that store the master packages and/or individual inventory items from the inbound storage area 104 to the operations area 106. In another embodiment, the transportation vehicles may pick out requisite master packages and/or inventory items from one or more ISUs and transport the requisite master packages and/or the inventory items to the operations area 106.

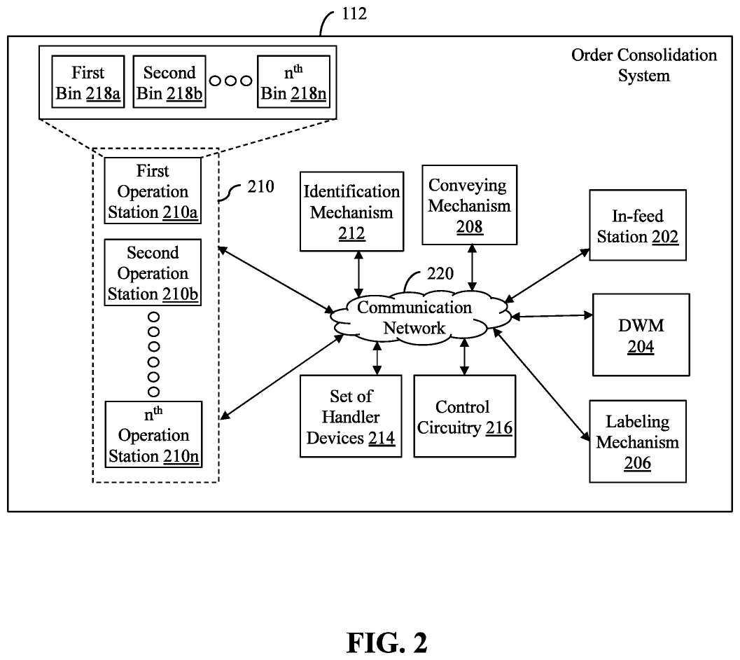

The operations area 106 may include an order consolidation system 112 for executing nₜₕ level sorting and order consolidation for fulfilment of orders. The order consolidation system 112 may be a standalone system that includes various components for receiving master packages from the inbound storage area 104, sorting the master packages to nₜₕ packaging level, and consolidating orders. The various components of the order consolidation system 112 may include, but are not limited to, a conveying system, a dimensioning and weighing mechanism (DWM), an identification mechanism, a set of operation stations, or the like. The order consolidation system 112 is illustrated and explained in detail in conjunction with FIG. 2.

The outbound storage area 108 may include one or more delivery vehicles (e.g., first through third delivery vehicles 114a-114c) for transporting various delivery packages to their corresponding delivery locations, based on various order requests. Each delivery package may be a consolidated set of items and/or master packages that correspond to an order request.

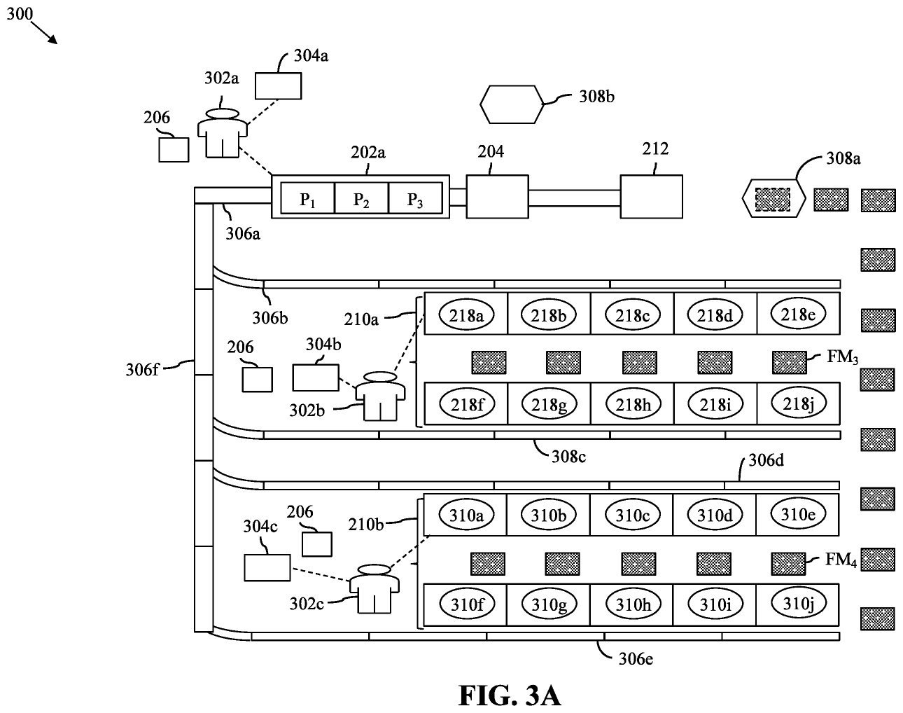

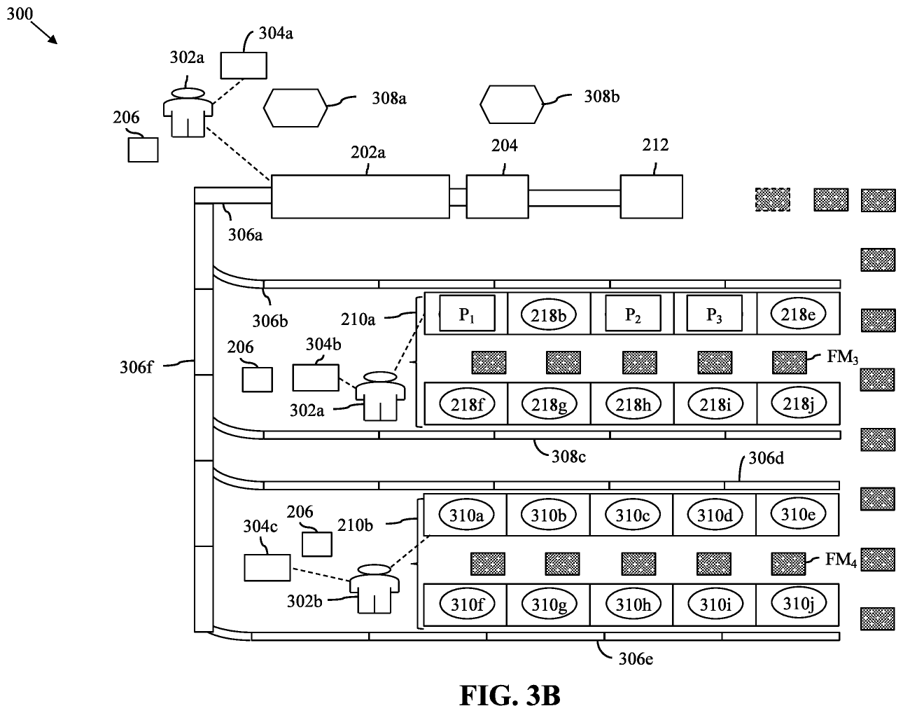

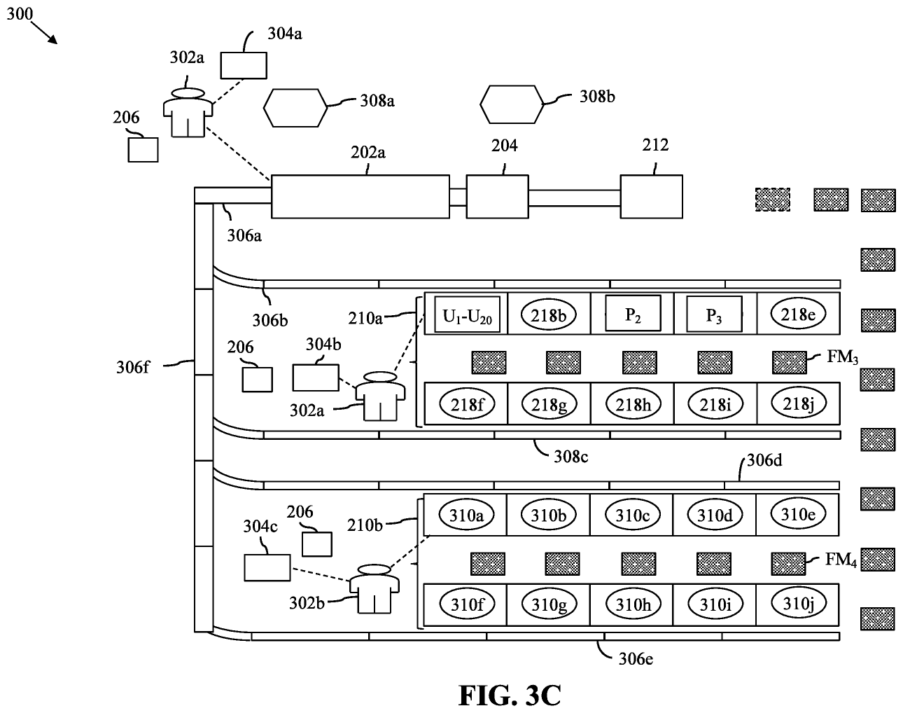

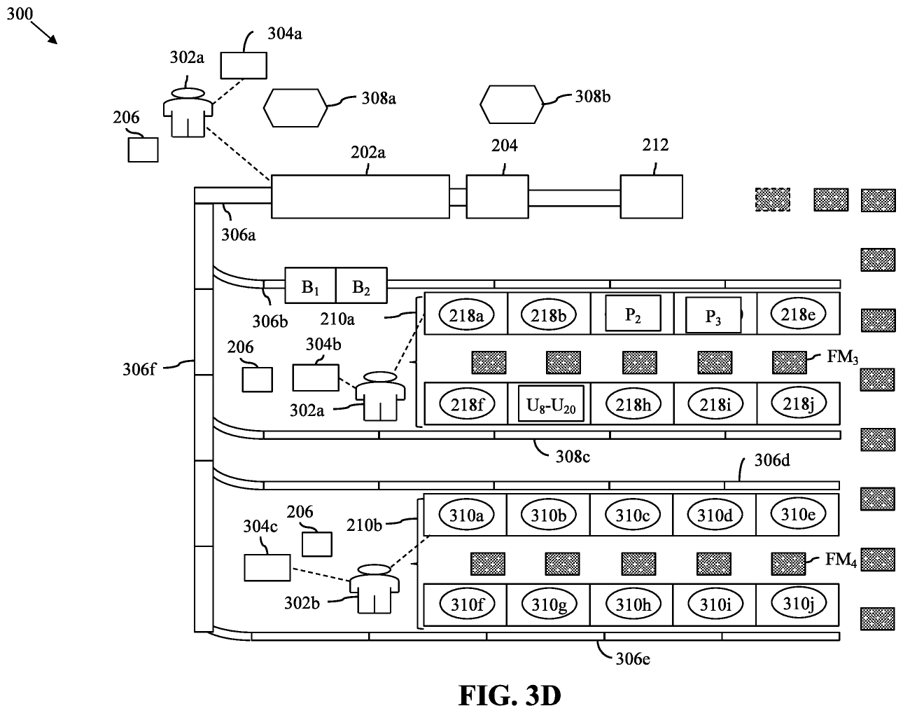

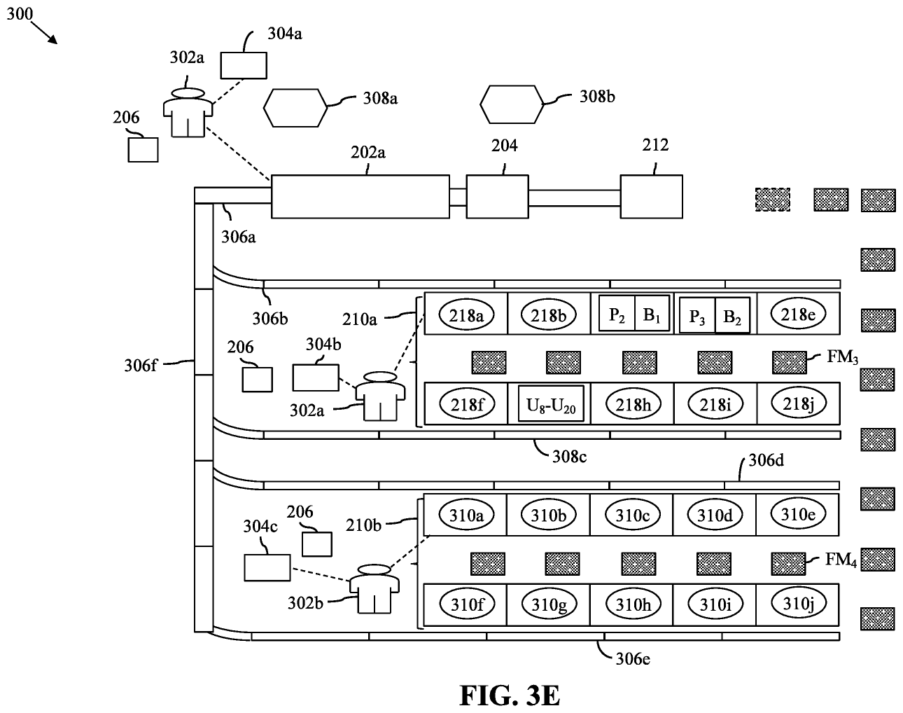

In operation, a management server at the facility 102 may receive order requests from multiple vendors. Each order request may include one or more order lines that correspond to one or more items, respectively. Each order line may be indicative of a single item and an order quantity of the item. Based on the order lines in the order requests, the transportation vehicles may transport, from the inbound storage area 104 to the operations area 106, master packages of the items or ISUs that store the master packages of the items required for fulfilling the order requests. The master packages may be fed to the order consolidation system 112, enabling sortation and consolidation of the master packages and/or individual items stored in the master packages for the fulfilment of all the order lines of the order requests. Consolidated delivery packages corresponding to the order requests are then transported from the operations area 106 to the outbound storage area 108 from where the first through third delivery vehicles 114a-114c transport the delivery packages to corresponding delivery locations. Various aspects of item sortation and order consolidation are described later in detail in conjunction with FIGS. 3A-3E.

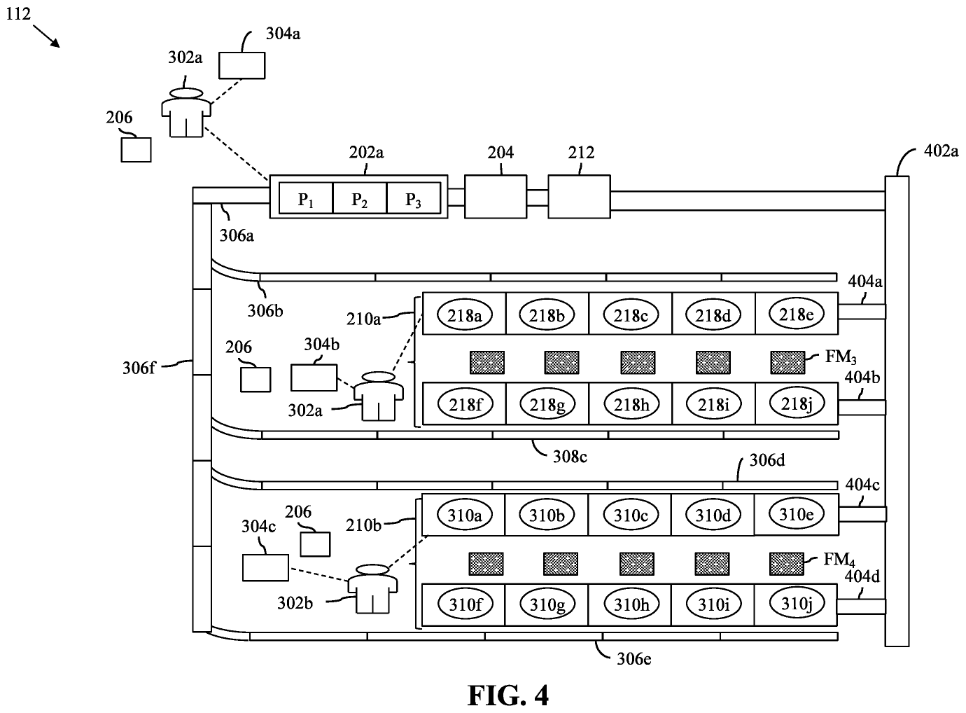

FIG. 2 is a block diagram that illustrates the order consolidation system 112, in accordance with an exemplary embodiment of the present disclosure. The order consolidation system 112 includes an in-feed station 202, a DWM 204, a labeling mechanism 206, a conveying mechanism 208, first through nₜₕ operation stations 210a-210n (hereinafter, collectively referred to as ‘the set of operation stations 210’), an identification mechanism 212, a set of handler devices 214, and control circuitry 216. The conveying mechanism 208 may include a set of conveyors, a set of transportation vehicles, or a combination thereof as described in FIGS. 3A-3E and 4.

The in-feed station 202 may be configured to receive (i.e., induct) master packages and/or individual items for sorting and/or consolidation. The in-feed station 202 may be operated by one or more handlers (e.g., human operators or automated robots). The one or more handlers may feed master packages and/or inventory items to the in-feed station 202, based on instructions received from the control circuitry 216. In a scenario where the handlers are robots, the one or more handlers may directly receive instructions from the control circuitry 216. In another scenario where the one or more handlers are human operators, the in-feed station 202 may include the set of handler devices 214 for displaying the instructions received from the control circuitry 216. The in-feed station 202 may be connected to the DWM 204 and the identification mechanism 212 by the conveying mechanism 208.

The DWM 204 may include suitable logic, circuitry, interfaces, and/or code, executable by the circuitry, to determine a set of dimensions and a weight of each master package received or inducted at the in-feed station 202. For example, the DWM 204 may include an ultrasonic sensor, a set of light array sensors, and a set of load cells to determine a height, a length and a breadth, and a weight, respectively, of each master package or unit of item received at the in-feed station 202. On determination of the set of dimensions and the weight of each master package, each master package may be conveyed towards the identification mechanism 212.

The labeling mechanism 206 may include suitable logic, circuitry, interfaces, and/or code, executable by the circuitry, to apply a physical label (e.g., an alphanumeric code, a barcode, a quick response code, or the like) on a master package, a batch of items, or an inventory item. Each handler at each operation station 210 may be in possession of an instance of the labeling mechanism 206. In a non-limiting example, the labeling mechanism 206 may include a labeling head for dispensing physical labels, an applicator for applying each physical label on a corresponding master package, and a guide mechanism for applying each physical label at a required position on the corresponding master package consistently. The applied physical label may be indicative of one or more details of a corresponding item, a corresponding batch, or a corresponding master package. For example, a first physical label on a first master package may be indicative of a set of dimensions of the first master package, a weight of the first master package, an item identification code (e.g., a stock keeping unit code), or the like.

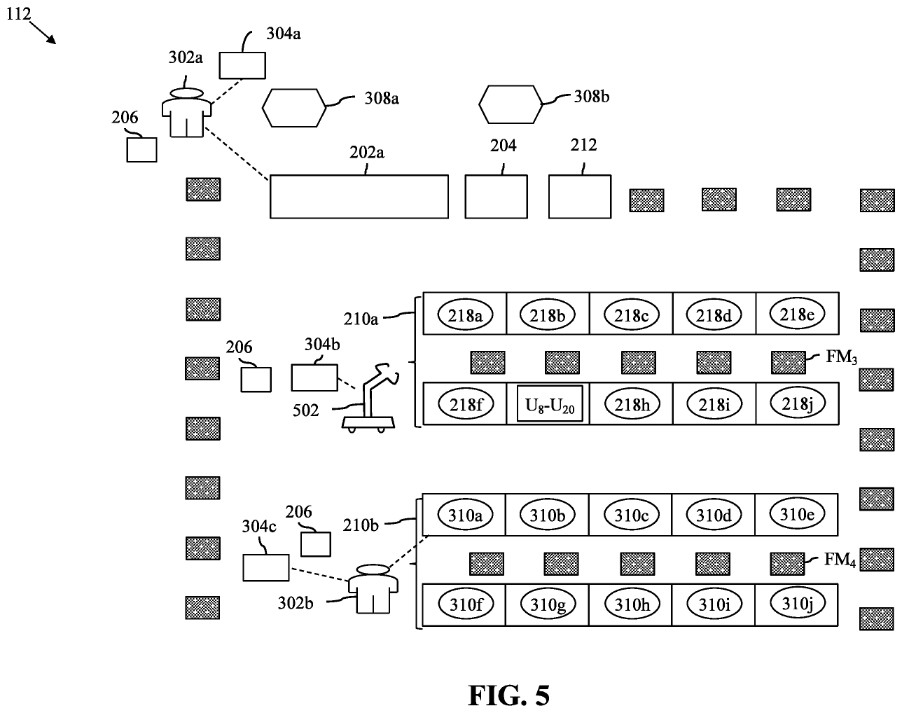

The conveying mechanism 208 may include a set of transportation vehicles, a set of conveyors, or a combination thereof. The conveying mechanism 208 may convey master packages and/or individual items between various stations or bins (e.g., the in-feed station 202 and the set of operation stations 210) of the order consolidation system 112. Different types of the conveying mechanism 208 are explained in detail in conjunction with FIGS. 3A-3E, 4, and 5. FIGS. 3A-3E illustrates an exemplary scenario where the conveying mechanism 208 includes a combination of static conveyors and transportation vehicles. FIG. 4 illustrates another exemplary scenario where the conveying mechanism 208 is solely composed of static conveyors. FIG. 5 illustrates an exemplary scenario where the conveying mechanism 208 is solely composed of transportation vehicles.

The set of operation stations 210 may include multiple operation stations for performing different operations related to sortation and consolidation of master packages and/or inventory items. Each operation station 210 may be operated by one or more handlers and may include multiple bins. For example, as shown in FIG. 2, the first operation station 210a includes first through nₜₕ bins 218a-218n. Each of the first through nₜₕ bins 218a-218n may include one or more totes for receiving master packages and/or individual inventory items and may be designated (i.e., selected) in real-time as a segregation bin or a consolidation bin.

One or more bins from the first through nₜₕ bins 218a-218nmay be designated as segregation bins for splitting master packages into constituent items and segregating the constituent items into batches for fulfilling order lines. In a non-limiting example, the first bin 218a may be designated as a segregation bin for splitting master packages of a first item that are received at the first bin 218a. For example, a handler at the first bin 218a (i.e., designated as the segregation bin) may be instructed to split each master package of the first item that is received at the first bin 218a to a subsequent level (for example, a unit level) to obtain individual units of the first item or secondary packages contained in the corresponding master package. The handler may be further instructed to segregate the obtained units of the first item or the secondary packages into batches required for fulfilling the set of order lines corresponding to the first item. The instructions may be communicated to the handler by displaying the instructions on a corresponding handler device 214 at the first operation station 210a.

Master packages and/or inventory items pertaining to an order line may be collected at a bin (for example, one of the first through nₜₕ bins 218a-218n) that is designated as the consolidation bin, for order consolidation. For example, a first set of master of packages, a first set of individual items, or a first batch of the first item that are required to fulfill a first order line for the first item may be collected at the first bin 218a, which is designated as the consolidation bin for the first order line. Likewise, a second set of master of packages, a second set of individual items, or a second batch of the first item that are required to fulfill a second order line for the first item may be collected at the second bin 218b, which is designated as the consolidation bin for the second order line. In another example, various sets of master packages and/or various sets of items, required to fulfill various order lines pertaining to a same delivery location or a same order request may be collected at a single consolidation bin for consolidation. Likewise, the bins of other operation stations 210b-210n are designated in real-time as segregation bins or consolidation bins.

The identification mechanism 212 may include suitable logic, circuitry, interfaces, and/or code, executable by the circuitry, to select (i.e., designate) a bin for a specific purpose such as splitting, segregating, or consolidating master packages, batches, or individual items. The identification mechanism 212 may select a bin for the specific purpose based on various factors such as, but not limited to, a number of received order requests, a number order lines in each order request, a number of order lines corresponding to each item, a number of available operation stations 210, a number of available bins at each operation station 210, or the like. Examples of the identification mechanism 212 may include, but are not limited to, 3-Dimensional (3D) label scanners, 3D barcode scanners, 3D image capturing devices, or the like. In a non-limiting example, the identification mechanism 212 and the DWM 204 are shown are discrete entities. In another embodiment, the identification mechanism 212 and the DWM 204 may be integrated with into a single system (not shown) without deviating from the scope of the disclosure.

In some embodiments, some functionalities of the DWM 204 and the identification mechanism 212 may be combined in a form of an imaging system that uses multiples cameras in conjunction with a high speed one-dimensional (1D) barcode auto scanning system. The multiple cameras and the high speed 1D barcode auto scanning system may be connected by Ethernet, enabling the multiple camera units to effectively read barcodes and measure the set of dimensions of each master package, batch, or individual item.

The set of handler devices 214 may include handler devices associated with each of the set of operation stations 210. The set of handler devices 214 may display instructions communicated by the control circuitry 216 to the handlers. It will be apparent to those of skill in the art that the set of handler devices 214 may offer other functionalities without deviating from the scope the disclosure. In one embodiment, the set of handler devices 214 may be used by the corresponding handlers to report any issue or error pertaining to any component of the order consolidation system 112. Example of the set of handler devices 214 may include, but are not limited to, interactive display screens, laptops, desktops, tablets, phablets, mini-computers, or the like.

The control circuitry 216 may include suitable logic, circuitry, interfaces, and/or code, executable by the circuitry, to facilitate various sorting and consolidation operations of the order consolidation system 112. Examples of the control circuitry 216 may include, but are not limited to, personal computers, laptops, mini-computers, mainframe computers, any non-transient and tangible machine that can execute a machine-readable code, cloud-based servers, distributed server networks, or a network of computer systems. The control circuitry 216 may be realized through various web-based technologies such as, but not limited to, a Java web-framework, a .NET framework, a personal home page (PHP) framework, or any other web-application framework. It will be understood by a person having ordinary skill in the art that the control circuitry 216 may execute other storage facility management operations as well along with facilitating the sorting and consolidation operations.

The control circuitry 216 may be configured to control an operation of the order consolidation system 112 for sorting master packages and/or individual items for order consolidation. In other words, the control circuitry 216 may control various components included in the order consolidation system 112 for the order consolidation. For example, the control circuitry 216 may be configured to control the conveying mechanism 208 for conveying the master packages and/or the individual items between various stations of the order consolidation system 112. For example, based on an order line for a first item in a first order request, the control circuitry 216 may control the conveying mechanism 208 to convey a set of master packages of the first item to the in-feed station 202. Other operations of the control circuitry 216 are explained in detail in FIGS. 3A-3E.

The communication network 220 is a medium through which instructions, commands, and messages are transmitted among the in-feed station 202, the DWM 204, the labeling mechanism 206, the conveying mechanism 208, the set of operation stations 210, the identification mechanism 212, the set of handler devices 214, and the control circuitry 216. Examples of the communication network 220 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities that constitute the order consolidation system 112 may connect to the communication network 220 in accordance with various wired and wireless communication protocols, such as Transmission Control Protocol and Internet Protocol (TCP/IP), User Datagram Protocol (UDP), Long Term Evolution (LTE) communication protocols, or any combination thereof

In operation, the control circuitry 216 may receive, from the management server at the facility 102 or an external server, a set of order requests (e.g., first and second order requests). Each order request may include one or more order lines for one or more items, respectively. The control circuitry 216 may be configured to identify a set of order lines in the set of order requests that correspond to the same item. For example, the control circuitry 216 may identify that first and second order lines of the first and second order requests, respectively, correspond to the first item.

Each of the first and second order lines may be indicative an order quantity for the first item. For fulfilling the first and second order lines, the control circuitry 216 may select a set of master packages of the first item based on a cumulative order quantity of the first and second order lines and a count of units of the first item included in each of the selected set of master packages. The control circuitry 216 may select the set of master packages such that a difference between the count of units included in the set of master packages and the cumulative order quantity of the first and second order lines is less than a count of units included in each master package of the first item. In one embodiment, a count of units included in each master package may be different, i.e., different master packages of the first item may include varying quantities of the first item. In such a scenario, the set of master packages may be selected such that the difference between the count of units included in the set of master packages and the cumulative order quantity is less than a count of units included in a smallest master package of the first item.

Based on the selection of the set of master packages, the control circuitry 216 may identify one or more master packages, of the set of master packages, to be split at a unit level for the fulfilment of the first and second order lines. The one or more master packages may be selected based on the order quantity of each of the first and second order lines and the count of units in each of the set of master packages, such that a number of master packages to be split at the unit level is minimum. The selected set of master packages is fed to the in-feed station 202. The control circuitry 216 may control the conveying mechanism 208 for conveying the one or more master packages to a bin (e.g., the first bin 218a) of an operation station (e.g., the first operation station 210a) that is selected as the segregation bin by the identification mechanism 212. The control circuitry 216 may control the conveying mechanism 208 to convey remaining master packages to another bin (e.g., the third bin 218c) of an operation station that is selected as the consolidation bin by the identification mechanism 212. The control circuitry 216 may communicate instructions to a handler at the first bin 218a to split the one or more master packages at the unit level to obtain individual units of the first item and segregate the individual units of the first item into one or more batches of the first item based on the first and second order lines. The one or more batches are fed to the identification mechanism 212.

The control circuitry 216 may control the conveying mechanism 208 to convey the one or more batches from the identification mechanism 212 to the third bin 218c that is selected as the consolidation bin. The control circuitry 216 may instruct the handlers operating the third bin 218c to consolidate the one or more batches and the remaining master packages into one or more order line packages, respectively, for fulfilment of the first and second order lines. The operations performed by the order consolidation system 112 for item sortation and order consolidation are explained in detail in FIGS. 3A-3E.

FIGS. 3A-3E represent schematic diagrams that illustrate an exemplary scenario 300 for order consolidation by the order consolidation system 112, in accordance with an exemplary embodiment of the present disclosure. FIGS. 3A-3E are explained in conjunction with FIG. 2. The order consolidation system 112 includes the in-feed station 202, the DWM 204, the labeling mechanisms 206, the first and second operation stations 210a and 210b, the identification mechanism 212, and the control circuitry 216 (as shown in FIG. 2). The in-feed station 202 and the first and second operation stations 210a and 210b may be handled by first through third handlers 302a-302c, respectively. The order consolidation system 112 further includes first through third handler devices 304a-304c (i.e., the set of handler devices 214) for use by the first through third handlers 302a-302c, respectively. For the sake of brevity, the first through third handlers 302a-302c are shown to be human operators. For the sake of brevity, the first and second operation stations 210a and 210b are shown to include ten bins each (i.e., first through tenth bins 218a-218j and eleventh through twentieth bins 310a-310j, respectively). It will be apparent to those of skill in the art that the first and second operation stations 210a and 210b may include any number of bins without deviating from the scope of the disclosure. The conveying mechanism 208 may include first through sixth conveyors 306a-306f and first and second transportation vehicles 308a and 308b. In another embodiment, the order consolidation system 112 may not include any transportation vehicles (e.g., the first and second transportation vehicles 308a and 308b) and may be composed of only conveyors (as shown in FIG. 4). In another embodiment, the order consolidation system 112 may not include the second through sixth conveyors 306b-306f and the operations performed by the second through sixth conveyors 306b-306f may be performed by the first and second transportation vehicles 308a and 308b (as shown in FIG. 5).

The first and second transportation vehicles 308a and 308b (hereinafter, collectively referred to as ‘the transportation vehicles 308’) are robotic vehicles (i.e., autonomous guided vehicles, AGVs) used in the facility 102 for picking, carrying, and transporting the master packages, batches of items, and/or individual items from one location to another location. The transportation vehicles 308 may be configured to communicate with the control circuitry 216 via the communication network 220 by using various wired, wireless, or optical communication protocols. The transportation vehicles 308 may vary in terms of sizes, dimensions, weight lifting capacity, or the like. Each transportation vehicle 308 may incorporate a mini-conveyor that allows the transportation vehicles 308 to receive and place the master packages, batches, and/or the individual items at various bins of the order consolidation system 112. The transportation vehicles 308 may be receptive to instructions and/or commands received from the control circuitry 216. For example, the transportation vehicles 308 may be controlled by the control circuitry 216. The transportation vehicles 308 may traverse the operations area 106 by way of various floor markers (e.g., third and fourth floor markers FM₃ and FM₄) included in the operations area 106.

In one embodiment, the control circuitry 216 may receive the first and second order requests from the external server. The control circuitry 216 may identify that the first and second order request include the first and second order lines that correspond to the same item, i.e., the first item. The first and second order lines may be indicative of the first and second order quantities for the first item, respectively.

Based on the first and second order quantities, the control circuitry 216 determines a minimum count of master packages of the first item required to fulfill the first and second order lines. The control circuitry 216 may express each order quantity (e.g., the first and second order quantities) as a function of a number of master packages and a number of individual units of the first item required to fulfill a corresponding order line. For example, when the first order quantity is equal to ‘22’, the control circuitry 216 may express ‘22’ as a sum of ‘20’ and ‘2’, where ‘20’ is the count of units included in each master package of the first item and ‘2’ is a number of individual units of the first item required. When the first order quantity is not an exact multiple of the count of the first item included in each master package, a master package may be split at a unit level to obtain the required individual units of the first item. In another example, where an order quantity of an order line is equal to ‘47’, the control circuitry 216 may express ‘47’ as a sum of ‘40’ and ‘7’, where ‘40’ is the count of units of the first item included in two master packages of the first item and ‘7’ is a number of individual units of the first item required. Such a scenario implies a requirement of two master packages and ‘7’ individual units of the first item for fulfilling the order line. For each order line, the control circuitry 216 may attempt to fulfil the order line by attempting to minimize splitting of master packages.

In one exemplary scenario, the first and second order lines may indicate the first order quantity ‘22’ and the second order quantity ‘25’, respectively. Thus, the cumulative order quantity of the first and second order lines is a sum of the first and second order quantities (i.e., 22+25=47). The control circuitry 216 may select a set of master packages (i.e., the minimum count) for the first and second order lines such that a difference between the count of units included in the set of master packages and the cumulative order quantity is less than a count of units included in each master package. Thus, in a scenario where each master package of the first item includes ‘20’ units of the first item, the control circuitry 216 may select three master packages (i.e., first through third master packages P₁-P₃) of the first item such that the difference (i.e., 60−47=13) between the count of units (i.e., ‘60’) included in the first through third master packages P₁-P₃ and the cumulative order quantity (i.e., ‘47’) is less than a count of units (i.e., ‘20’) included in each master package. In another embodiment, a count of units included in each master package may be different, i.e., different master packages of the first item may include varying quantities of the first item. In such a scenario, the set of master packages may be selected such that the difference between the count of units included in the selected set of master packages and the cumulative order quantity (i.e., ‘47’) is less than a count of units included in a smallest master package of the first item. For the sake of brevity, it is assumed that the count of units in each master package of the first items is same, i.e., ‘20’.

Based on the selection, the control circuitry 216 may communicate instructions (e.g., transit instructions) to one or more transportation vehicles (e.g., the first transportation vehicle 308a) to transport one or more ISUs (e.g., the first ISU 110a) that store the first through third master packages P₁-P₃ from the inbound storage area 104 to the operations area 106. In another embodiment, the control circuitry 216 may communicate the transit instructions to one or more transportation vehicles (e.g., the first transportation vehicle 308a) to transport the first through third master packages P₁-P₃ from the inbound storage area 104 to the operations area 106. The transit instructions may be indicative of a first optimal path to reach a location of each of the ISUs from a current location of the first transportation vehicle 308a, an identifier of each of the first through third master packages P₁-P₃, a second optimal path to reach a location of the in-feed station 202 from the inbound storage area 104.

Based on the transit instructions, the first transportation vehicle 308a may retrieve the first ISU 110a storing the first through third master packages P₁-P₃ or the first through third master packages P₁-P₃ from the inbound storage area 104, and approach the in-feed station 202. When the first transportation vehicle 308a approaches the in-feed station 202, the control circuitry 216 may instruct the first handler 302a at the in-feed station 202 to feed the first through third master packages P₁-P₃ to the in-feed station 202. The control circuitry 216 may instruct the first handler 302a by displaying one or more instructions on the first handler device 304a. In an alternate embodiment, the first transportation vehicle 308a may directly feed the first through third master packages P₁-P₃to the in-feed station 202. As shown in FIG. 3A, the in-feed station 202 has received the first through third master packages P₁-P₃.

The first conveyor 306a may convey the first through third master packages P₁-P₃ (i.e., the selected set of master packages) from the in-feed station 202 towards the DWM 204 and the identification mechanism 212. In a non-limiting example, the in-feed station 202, the DWM 204, and the identification mechanism 212 are shown to be connected by a single conveyor (i.e., the first conveyor 306a). It will be apparent to those of skill in the art that the in-feed station 202, the DWM 204, and the identification mechanism 212 may be connected by way of multiple conveyors, enabling simultaneous induction of multiple packages or by way of the transportation vehicles 308.

As described in the foregoing, the DWM 204 may determine a set of dimensions and a weight of each of the first through third master packages P₁-P₃. The DWM 204 may communicate, to the control circuitry 216, the set of dimensions and the weight of each of the first through third master packages P₁-P₃. The control circuitry 216 may compare the set of dimensions and the weight of each of the first through third master packages P₁-P₃ against a pre-determined set of dimensions and a pre-determined weight, respectively, stored in a memory of the control circuitry 216. In a scenario where the set of dimensions or the weight of a master package of the first through third master packages P₁-P₃ does not match the pre-determined set of dimensions or the pre-determined weight, respectively, the control circuitry 216 may reject a corresponding master package. When the master package is rejected, the control circuitry 216 may control the conveying mechanism 208 to convey the rejected master package to the identification mechanism 212. The identification mechanism 212 may select a bin (e.g., the tenth bin 218j) as a rejection bin. The control circuitry 216 may control a transport vehicle (e.g., the first transport vehicle 308a) to transport the rejected master package from the identification mechanism 212 to the selected rejection bin. Consequently, the control circuitry 216 may communicate transit instructions to a transportation vehicle (e.g., the first transportation vehicle 308a) to retrieve a new master package of the first item from the inbound storage area 104 for replacing the rejected master package. For example, if there exists a mismatch between the set of dimensions of the first master package P₁ and the pre-determined set of dimensions, the control circuitry 216 may reject the first master package P₁. The control circuitry 216 may consequently select a fourth master package to replacing the first master package P₁. The control circuitry 216 may instruct the first transportation vehicle 308a to retrieve the fourth master package from the inbound storage area 104. For the sake of brevity, it is assumed that the set of dimensions and the weight of each of the first through third master packages P₁-P₃ match the pre-determined set of dimensions and the pre-determined weight, respectively.

As the first through third master packages P₁-P₃ are conveyed by the first conveyor 306a or before the first through third master packages P₁-P₃ are conveyed, the first handler 302a may use the labeling mechanism 206 to apply a physical label on each of the first through third master packages P₁-P₃ (as described in the forgoing description of FIG. 2). The physical label on each of the first through third master packages P₁-P₃ may be indicative of details of a corresponding master package such as, but not limited to, the set of dimensions and the weight of the corresponding master package, an identifier of the first item, the count of the first items included in each master package, or the like.

The control circuitry 216 may be further configured to identify whether it is required to split any of the first through third master packages P₁-P₃ for fulfilling the first and second order lines. The control circuitry 216 may identify whether it is required to split any of the first through third master packages P₁-P₃ based on the order quantities of each of the first and second order lines and the count of units of the first item included in each of the first through third master packages P₁-P₃. In the current exemplary scenario, the control circuitry 216 may determine that for fulfilling the first and second order lines having the respective first and second order quantities ‘22’ and ‘25’, two master packages of the first item and seven units of the first item are required. Hence, splitting one of the first through third master packages P₁-P₃ at the unit level is required to obtain seven (i.e., (22−20)+(25−20)=7)) units of the first item. Thus, the control circuitry 216 may identify the first master package P₁ for splitting at the unit level. In another exemplary scenario, where the order quantities of the first item are ‘17’ and ‘18’, the cumulative order quantity is equal to ‘35’ (i.e., 17+18=35). In such a scenario, the control circuitry 216 may select two master packages such that the difference (i.e., ‘5’) between a count of units included in the two master packages (i.e., ‘40’) and the cumulative order quantity (i.e., ‘35’) is less than the count of units (i.e., ‘20’) in each master package. Since both the order quantities are less than the count of units of the first item (i.e., ‘20’) in each master package, the control circuitry 216 may identify that both selected master packages are to be split at the unit level to fulfil the first and second order lines.

Referring now to FIG. 3B, the control circuitry 216 may identify the first master package P₁ for splitting at the unit level. As the first through third master packages P₁-P₃ are conveyed to the identification mechanism 212, the identification mechanism 212 may select a set of bins for fulfilling the first and second order lines. In a non-limiting example, the identification mechanism 212 may select the first bin 218a as the segregation bin and the third and fourth bins 218c and 218d as consolidation bins for the first and second order lines, respectively.

The control circuitry 216 may communicate instructions to a transportation vehicle (e.g., the first transportation vehicle 308a) to receive the first master package P₁ from the identification mechanism 212 and transport the first master package P₁ to the first bin 218a. For example, the control circuitry 216 may control the first transportation vehicle 308a for conveying the first master package P₁ to the first bin 218a.

The control circuitry 216 may instruct another transportation vehicle (e.g., the second transportation vehicle 308b) to transport remaining master packages (i.e., the second and third master packages P₂ and P₃) to corresponding consolidation bins (e.g., the third and fourth bins 218c and 218d). For example, the control circuitry 216 may control the second transportation vehicle 308b to transport the second and third master package P₂ and P₃ to the third and fourth bins 218c and 218d, respectively. In another embodiment, the control circuitry 216 may instruct the same transportation vehicle to simultaneously transport the first master package P₁ to the first bin 218a and the second and third master packages P₂ and P₃ to the third and fourth bins 218c and 218d, respectively.

As shown in FIG. 3B, the first bin 218a receives the first master package P₁ from the first transportation vehicle 308a. The control circuitry 216 may communicate instructions to the second handler device 310b to instruct the second handler 302b to split the first master package P₁ at the unit level. The instructions communicated by the control circuitry 216 may be displayed by the second handler device 304b. For the sake of brevity, the first and second operation stations 210a and 210b are each shown to be operated by a single handler (e.g., the second and third handlers 302b and 302c, respectively). It will be apparent to those of skill in the art that each operation station 210 may include any number of handlers for performing various operations without deviating from the scope of the disclosure.

Referring now to FIG. 3C, based on the instructions, the first master package P₁ is split at the unit level by the second handler 302b to obtain a plurality of units (i.e., U₁-U₂₀) of the first item that are contained within the first master package P₁. In one embodiment, the first operation station 210a may feature pick-to-light and put-to-light systems (not shown) that facilitate operations performed by the second handler 302b. The pick-to-light and put-to-light systems may be light-directed systems that offer visual cues to the second handler 302b to pick received master packages (e.g., the first master package P₁), split the received master packages at the unit level, and store the individual units obtained by splitting each master package. Usage and applications of pick-to-light and put-to-light systems are well known to those of ordinary skill in the art.

The control circuitry 216 may further instruct the second handler 302b to segregate the plurality of units U₁-U₂₀ of the first item into batches. The communicated instructions may be displayed on the second handler device 304b. The communicated instructions may instruct the second handler 302b to form first and second batches B₁ and B₂ of ‘2’ and ‘5’ units of the first item for fulfilling the first and second order lines, respectively. Based on the displayed instructions, the first and second batches B₁ and B₂ are thus formed and placed on the second conveyor 306b by the second handler 302b. The second handler 302b may label the first and second batches B₁ and B₂ using the labeling mechanism 206. The first operation station 210a may incorporate pick-to-light and put-to-light systems to assist the second handler 302b in the segregation of the plurality of units U₁-U₂₀. The first and second batches B₁ and B₂ may be formed by placing items in one or more totes (e.g., first and second totes) placed at the first bin 218a. For example, the second handler 302b may form the first and second batches B₁ and B₂ by placing ‘2’ and ‘5’ units of the first item in the first and second totes, respectively. In a non-limiting example, remaining units U₈-U₂₀ (i.e., excess units) of the first item may be placed in the seventh bin 218g at the first operation station 210a and may be utilized when more order lines for the first item are identified by the control circuitry 216. For example, the control circuitry 216 may receive a third order request that includes a third order line for ‘28’ units of the first item. In such a scenario, a fifth master package of the first item and the units U₈-U₁₅ of the remaining units U₈-U₂₀ may be consolidated within a single order line package for fulfilment of the third order line. In another embodiment, the remaining units U₈-U₂₀ may be introduced back to the inbound storage area 104 in the form of a master package having 17 units of the first item to be utilized later.

Referring now to FIG. 3D, the control circuitry 216 may control the second and sixth conveyors 306b and 306f to convey the first and second batches B₁ and B₂ to the first conveyor 306a. The control circuitry 216 may control the first conveyor 306a to convey the first and second batches B₁ and B₂ via the in-feed station 202, the DWM 204, and the identification mechanism 212. The control circuitry 216 may compare the set of dimensions and the weight of the first and second batches B₁ and B₂ to a pre-determined set of dimensions and a pre-determined weight of the first and second batches B₁ and B₂, respectively. If the control circuitry 216 determines that there's a mismatch between the set of dimensions or the weight of the first and second batches B₁ and B₂ and the second pre-determined set of dimensions or the second pre-determined weight, respectively, the control circuitry 216 may instruct the second handler 302b to discard the corresponding batch and may instruct the second handler 302b at the first bin 218a to form a new batch to replace the rejected batch. In a non-limiting example, it is assumed that there is no mismatch.

Consequently, the control circuitry 216 may control a transportation vehicle (e.g., the first transportation vehicle 308a) for receiving the first and second batches B₁ and B₂ from the identification mechanism 212 and conveying the first and second batches B₁ and B₂ to the third and fourth bins 218c and 218d, respectively, that are designated as the consolidation bins for the respective first and second order lines.

Referring now to FIG. 3E, the first and second batches B₁ and B₂ are conveyed to the third and fourth bins 218c and 218d, respectively. The control circuitry 216 may then communicate first and second sets of consolidation instructions to the second handler device 304b, respectively. Based on the first set of consolidation instructions, the second master package P₂ and the first batch B₁ are consolidated into a first order line package by the second handler 302b. Similarly, based on the second set of consolidation instructions, the third master package P₃ and the second batch B₂ are consolidated into a second order line package by the second handler 302b.

Various order line packages that correspond to each order request may be consolidated into a delivery package. For example, order line packages (e.g., the first order line package) pertaining to the first order request may be consolidated into a first delivery package. Similarly, order line packages (e.g., the second order line package) pertaining to the second order request may be consolidated into a second delivery package. In a non-limiting example, each order request of the received set of order requests may correspond to a single delivery package. For consolidation into a delivery package, each order line package corresponding to an order request (e.g., the first order request) may be conveyed by the conveying mechanism 208 to a bin of one of the first and second operation stations 210a and 210b. The control circuitry 216 may then control the first and second transportation vehicles 308a and 308b for transporting the first and second delivery packages to the outbound storage area 108. The first and second delivery packages may then be delivered to corresponding delivery locations by the first through third delivery vehicles 114a-114c. Thus, the order consolidation system 112 may further be utilized to sort and consolidate various order line packages into delivery packages.

In another embodiment, each master package may include various levels of packaging. For example, each of the first through third master packages P₁-P₃ may include a second level of packaging. The second level of packaging may include four secondary packages each containing five units of the first item (i.e., 4*5=20). In such a scenario, the control circuitry 216 may instruct the second handler 302b to split the first master package P₁ into first through fourth secondary packages. To obtain ‘7’ units of the first item for fulfilling the first and second order requests, the control circuitry 216 may further instruct the second handler 302b to split the first secondary package to the unit level and keep second through fourth secondary packages intact. In such a scenario, the first batch B₁ may include two units of the first item and the second batch B₂ may include one of the second through fourth secondary packages. It will be apparent to those of skill in the art that a master package may include ‘n’ levels of packaging and may be split and segregated in a manner that minimizes a number of touch points by handlers (e.g., the second handler 302b).

In another embodiment, each operation station 210 may include instances of the DWM (not shown) and the identification mechanism (not shown). In such a scenario, the first and second batches B₁ and B₂ need not be re-fed to the in-feed station 202. The set of dimensions and the weight of each unit in the first and second batches B₁ and B₂ may be compared to the second pre-determined set of dimensions and the second pre-determined weight by the DWM at the first operation station 210a. The first and second batches B₁ and B₂ may be consequently conveyed to the third and fourth bins 218c and 218d based on the selection by the identification mechanism at the first operation station 210a.

An order request may pertain to multiple items. In such a scenario, the control circuitry 216 may instruct handlers (e.g., the first and second handlers 302a and 302b) to consolidate master packages and/or individual items pertaining to the order request in a single delivery package or separate delivery packages based on various factors. For example, the control circuitry 216 may receive an order request indicative of order lines for second and third items. In a non-limiting example, master packages and/or individual items corresponding to the second and third items may be consolidated in separate delivery packages if the second item is delicate (e.g., electronics) and the third item is rugged (e.g., industrial equipment). In another non-limiting example, master packages and/or individual items corresponding to the second and third items may be consolidated in separate delivery packages if the second item is a perishable good (e.g., groceries) and the third item is a heavy weight item. Similarly, the control circuitry 216 may instruct the third handler 302c to form batches of mixed items when individual units of the multiple items are required to fulfill the order lines of an order request. Likewise, there may be various rules that are known in the art to facilitate efficient consolidation of different types of items.

The splitting of the first master package P₁ at the first bin 218a is driven by the control circuitry 216. Thus, a likelihood of human error is decreased in comparison to conventional sortation systems where a decision to split a master package is manual. Further, the order consolidation system 112 described in FIGS. 3A-3E is flexible and scalable. For example, the order consolidation system 112 of FIGS. 3A-3E may be implemented in any facility irrespective of the geometrical shape and size of the facility. Also, order handling capacity of the order consolidation system 112 of FIGS. 3A-3E may be increased by increasing a count of transportation vehicles, thus making the order consolidation system 112 easily scalable. Further, the order consolidation system 112 described in FIGS. 3A-3E is a closed system that constitutes an end-to-end solution for order consolidation. The order consolidation system 112 iteratively performs various operations (e.g., splitting of master packages into subsequent levels) at the bins of the operation stations 210 to achieve nₜₕ level sortation and order consolidation.

FIG. 4 represents a diagram 400 that illustrates the order consolidation system 112, in accordance with another exemplary embodiment of the present disclosure. FIG. 4 illustrates a scenario where the conveying mechanism 208 is solely composed of static conveyors, i.e., the order consolidation system 112 does not include any transportation vehicles (e.g., the transportation vehicles 308). In lieu of the transportation vehicles 308, the order consolidation system 112 utilizes the first through sixth conveyors 306a-306f, a seventh conveyor 402a, and first through fourth chutes 404a-404h. The first through fourth chutes 404a-404d may connect the seventh conveyor 402a to various bins of the first and second operation stations 106a and 106b. For example, the first and second chutes 404a and 404b may connect the seventh conveyor 402a to the first operation station 210a. Similarly, the third and fourth chutes 404c and 404d may connect the seventh conveyor 402a to the second operation station 210a. The seventh conveyor 402a may include a set of diverters (not shown) for directing master packages, batches, and/or individual items towards a corresponding operation station (e.g., the first operation station 210a). For example, a first diverter on the seventh conveyor 402a may direct the first master package P₁ into the first chute 404a to the first operation station 210a. It will be apparent to those of skill in the art that operation of the order consolidation system 112 in this embodiment may be similar to the operation of the order consolidation system 112 as described in FIGS. 3A-3E.

FIG. 5 represents a diagram 500 that illustrates the order consolidation system 112, in accordance with another exemplary embodiment of the present disclosure. FIG. 5 illustrates a scenario where the conveying mechanism 208 is solely composed of transportation vehicles, i.e., the order consolidation system 112 does not include any static conveyors. In lieu of the first through sixth conveyors 306a to 306f, the order consolidation system 112 of FIG. 5 utilizes the transportation vehicles 308 for conveying master packages, batches, and/or items between various locations (e.g., between the in-feed station 202 and DWM 204, between the first operation station 210a and the in-feed station 202a, or the like.). It will be apparent to those of skill in the art that operation of the order consolidation system 112 in this embodiment is similar to the operation of the order consolidation system 112 as described in FIGS. 3A-3E. Further, the order consolidation system 112 of FIG. 5 is shown to utilize an automated robot 502 as handler.

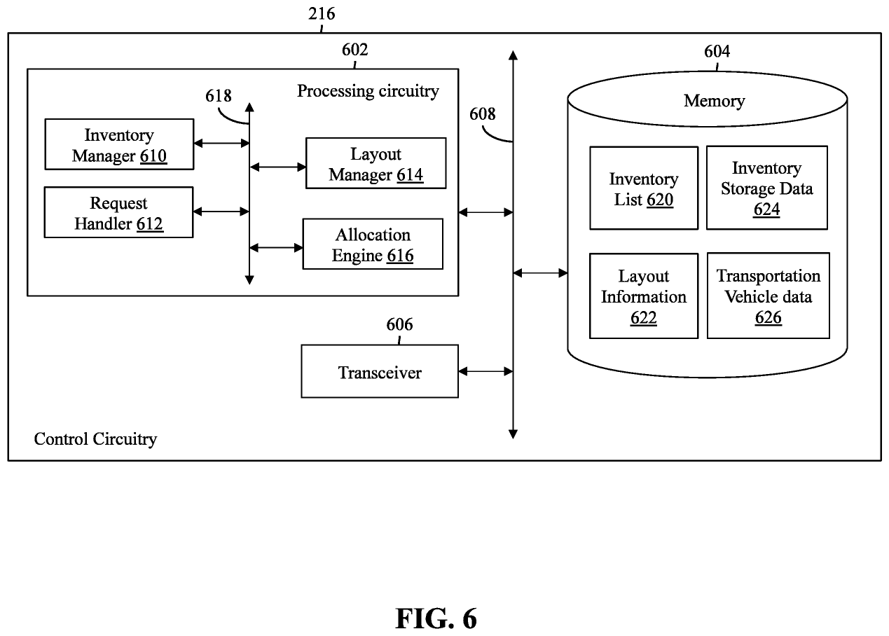

FIG. 6 is a block diagram that illustrates the control circuitry 216, in accordance with an exemplary embodiment of the present disclosure. The control circuitry 216 includes processing circuitry 602, a memory 604, and a transceiver 606 that communicate with each other by way of a communication bus 608. The processing circuitry 602 includes an inventory manager 610, a request handler 612, a layout manager 614, and an allocation engine 616 that communicate with each other by way of a communication bus 618. It will be apparent to a person of ordinary skill in the art that the control circuitry 216 is for illustrative purposes and not limited to any specific combination or hardware circuitry and/or software. For example, the control circuitry 216 may be implemented by a server system that includes a plurality of servers each configured to perform one or a combination of the functions of the server. Furthermore, the control circuitry 216 may be implemented by a plurality of devices that are operating over a cloud and communicating with devices in the facility 102 via the communication network 220.

The processing circuitry 602 includes suitable logic, circuitry, interfaces, and/or code, executed by the circuitry, for executing various operations, such as sorting operations, consolidation operations, or the like. The processing circuitry 602 may be configured to select master packages, identify master packages for splitting, and consolidate master packages, batches, and/or individual items into delivery packages, as described in foregoing descriptions of FIGS. 2, 3A-3E, 4, and 5. The processing circuitry 602 may execute the operations by way of the inventory manager 610, the request handler 612, the layout manager 614, and the allocation engine 616. Examples of the processing circuitry 602 include, but are not limited to, an ASIC processor, a RISC processor, a CISC processor, an FPGA, and the like.

The memory 604 includes suitable logic, circuitry, interfaces, and/or code, executed by the circuitry, to store an inventory list 620, layout information 622, inventory storage data 624, and transportation vehicle data 626. Examples of the memory 604 include, but are not limited to, a random-access memory (RAM), a read-only memory (ROM), a removable storage drive, a hard disk drive (HDD), a flash memory, a solid-state memory, and the like. In one embodiment, the memory 604 may be realized through various database technologies such as, but not limited to, Microsoft® SQL, Oracle®, IBM DB2®, Microsoft Access®, PostgreSQL®, MySQL® and SQLite®. It will be apparent to a person skilled in the art that the scope of the disclosure is not limited to realizing the memory 604 in the control circuitry 216, as described herein. In other embodiments, the memory 604 may be realized in form of an external database server or a cloud storage working in conjunction with the control circuitry 216, without departing from the scope of the disclosure.

The inventory list 620 may include a list of master packages and/or inventory items stored in the facility 102 and a number of units of each master package and/or inventory items stored in the facility 102. The layout information 622 may include information of the layout of the facility 102, such as location data of the ISUs 110. The layout information 622 may further include real-time path availability information of various paths in the facility 102. For example, a first path in the facility 102 may be under maintenance and unavailable for traversing.

The inventory storage data 624 is indicative of storage locations of the master packages and/or the inventory items stored in the ISUs 110. The inventory storage data 624 further includes the ISU markers of the ISUs 110. The ISU markers are unique codes assigned to each of the ISUs 110. For example, the ISU markers may be radio frequency identification (RFID) tags that are readable by the transportation vehicles 308. Thus, based on the inventory storage data 624, the control circuitry 216 is aware of the locations of all master packages and/or inventory items stored in the facility 102.

The transportation vehicle data 626 is indicative of details of the transportation vehicles 308 available in the facility 102. The details of the transportation vehicles 308 may include weight lifting capacity, size, and dimension of each transportation vehicle 308.

The transceiver 606 transmits and receives data over the communication network 220 using one or more communication network protocols. The transceiver 606 transmits various requests and messages to the set of handler devices 214 and the transportation vehicles 308, and receives requests and messages from the set of handler devices 214 and the transportation vehicles 308. Examples of the transceiver 606 include, but are not limited to, an antenna, a radio frequency transceiver, a wireless transceiver, a Bluetooth transceiver, an ethernet based transceiver, a universal serial bus (USB) transceiver, or any other device configured to transmit and receive data.

The inventory manager 610 manages the inventory list 620 stored in the memory 604. For example, the inventory manager 610 adds entries indicative of new master packages and/or inventory items to the inventory list 620 when the new master packages and/or the inventory items are stored in the facility 102. Further, the inventory manager 610 updates the inventory list 620 based on fulfilment of various order requests.

The request handler 612 processes all the order requests received from the external server, identifies corresponding order lines, and stores a record (i.e., the historical order data) of all historical order requests in the memory 604. Further, the request handler 612 selects the set of master packages for fulfilling the first set of order requests and identifies the one or more master packages to be split. The layout manager 614 manages the layout information 622. For example, if there is any change in the layout of the facility 102 (such as a change in the arrangement of the ISUs 110), the layout manager 614 updates the layout information 622 based on the change in the layout. The allocation engine 616 allocates transportation vehicles (e.g., the first transportation vehicle 308a) for performing various operations (e.g., transporting the first through third master packages from the inbound storage area 104 to the operations area 106). Further, the allocation engine 616 is responsible for identifying the optimal paths (e.g., the first and second optimal paths) to be traversed by the transportation vehicles 308.

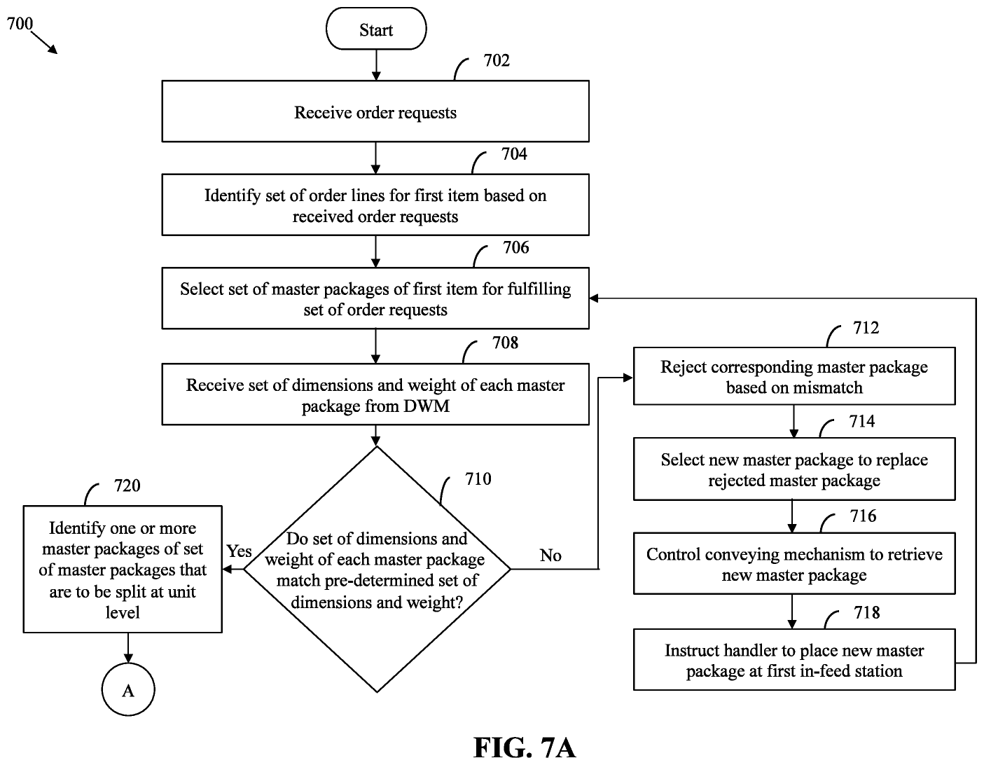

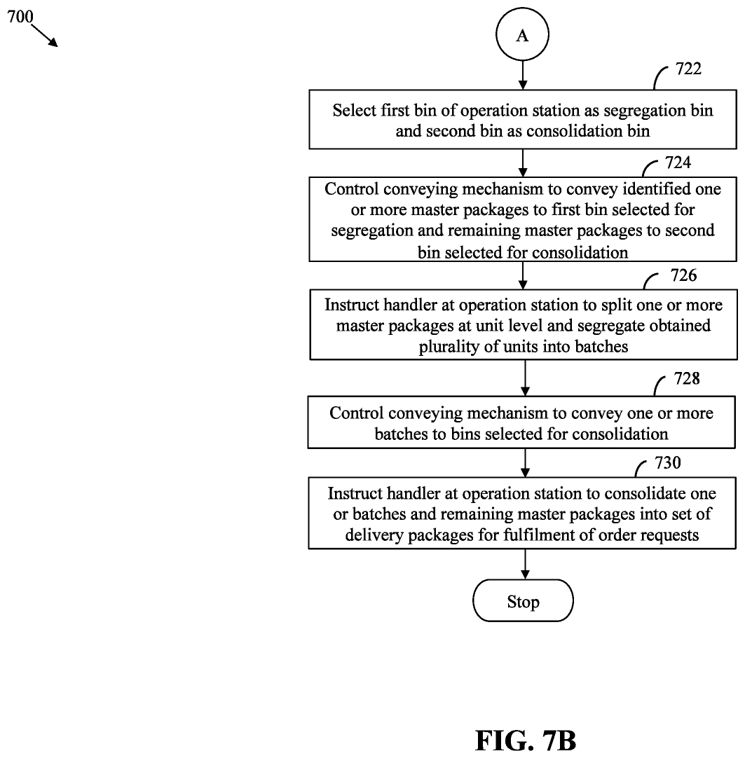

FIGS. 7A and 7B, collectively represent a flow chart 700 that illustrates a process (i.e., a method) for order consolidation by the order consolidation system 112, in accordance with an exemplary embodiment of the disclosure.

The process may generally start at step 702, where the control circuitry 216 receives a plurality of order requests (e.g., the first set of order requests). Each of the received order requests may include various order lines for various items, such that each order line corresponds to a single item and indicates an order quantity of the item. The process proceeds to step 704, where the control circuitry 216 identifies a set of order lines (e.g., the first and second order lines) for a first item based on the received plurality of order requests. The process proceeds to step 706, where the control circuitry 216 selects a set of master packages (e.g., the first through third master packages P₁-P₃) of the first item for fulfilment of the set of order lines for the first item. The set of master packages may be selected based on the cumulative order quantity indicated by the set of order lines and a count of units of the first item included in each of the set of master packages. The control circuitry 216 may control the conveying mechanism 208 to convey the set of master packages from the inbound storage area 104 to the in-feed station 202. The control circuitry 216 may instruct the first handler 302a to feed the set of master packages to the in-feed station 202. The first handler 302a may feed the set of master packages to the in-feed station 202.

The process proceeds to step 708, where the control circuitry 216 receives a set of dimensions and a weight of each of the set of master packages from the DWM 204. The process proceeds to step 710, where the control circuitry 216 determines whether the set of dimensions and the weight of each of the set of master packages match a pre-determined set of dimensions and a pre-determined weight, respectively.

If at step 710, it is determined that the set of dimensions or the weight of any of the set of master packages does not match the pre-determined set of dimensions or the pre-determined weight, respectively, the process proceeds to step 712. At step 712, the control circuitry 216 rejects corresponding master package based on the mismatch. The process proceeds to step 714, where the control circuitry 216 selects another master package (i.e., a new master package), from the inbound storage area 104, to replace the rejected master package. The process proceeds to step 716, where the control circuitry 216 controls the conveying mechanism 208 to retrieve the new master package from the inbound storage area 104. The process proceeds to step 718, where the control circuitry 216 instructs the first handler 302a to place the new master package at the in-feed station 202 (i.e., feed the new master package to the in-feed station 202). The process then proceeds to step 706 for the newly placed master package.

If at step 710, it is determined that the set of dimensions and the weight of each of the set of master packages match the pre-determined set of dimensions and the pre-determined weight, respectively, the process proceeds to step 720. At step 720, the control circuitry 216 identifies one or more master packages (e.g., the first master package), of the set of master packages, that are to be split at unit level to fulfil the set of order lines. The one or more master packages are identified based on the order quantity indicated by each of the set of order lines for the first item and the count of units of the first item in each of the set of master packages. The process then proceeds to process A as shown in FIG. 7B.

Referring now to FIG. 7B, the process A proceeds to step 722, where the identification mechanism 212 selects a bin of an operation station (e.g., the first bin 218a of the first operation station 210a) as the segregation bin and another bin of the operation station (e.g., the third and fourth bins 218c and 218d of the first operation station 210a) as the consolidations bins. The process proceeds to step 724, where the control circuitry 216 controls the conveying mechanism 208 to convey the identified one or more master packages to the bin selected for segregation (e.g., the first bin 218a as described in the foregoing description of FIGS. 3A-3E) and the remaining master packages, of the set of master packages, to the bins selected for consolidation (e.g., the third and fourth bins 218c and 218d as described in the foregoing description of FIGS. 3A-3E).

The process proceeds to step 726, where the control circuitry 216 instructs a handler (e.g., the second handler 302b) to split the identified one or more master packages at the unit level and segregate the obtained plurality of units into batches (e.g., the first and second batches B₁ and B₂). The handler may split each of the identified one or more master packages to obtain a plurality of units of the ordered item and segregate the plurality of units into one or more batches required for fulfilment of the identified order lines. The process proceeds to step 728, where the control circuitry 216 controls the conveying mechanism 208 to convey the one or more batches to the one or more bins selected for consolidation. The process proceeds to step 730, where the control circuitry 216 instructs a handler (e.g., the second handler 302b or the third handler 302c) at the one or more bins selected for consolidation to consolidate the one or more batches and the remaining master packages into the set of order line packages (e.g., the first and second order line packages) for the fulfilment of the first and second order lines. Consequently, the control circuitry 216 may control the conveying mechanism 208 to convey the order line packages corresponding to an order request to another bin that is selected for consolidating the order line packages into a delivery package (e.g., the first and second delivery packages).

Techniques consistent with the present disclosure provide, among other features a method and system for sorting and consolidating master packages and/or items for order fulfilment. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the width or scope.

The order consolidation system 112 facilitates nₜₕ level sortation and order consolidation using a regular linear sorter. Multiple levels of packaging within each master package can be scrutinized and selectively split so as to minimize a number of touch points for handlers. Consequently, efficiency and throughput of order fulfilment is vastly improved. Selection of master packages and determination of number of master packages to be split is determined by the control circuitry 216, enabling the control circuitry 216 to account for received order requests. The selection of master packages and determination of number of master packages to be split are performed by the control circuitry 216 in a manner that minimizes splitting of master packages. The control circuitry 216 takes into account a number of units included in each master package. So, the control circuitry 216 may select master packages of various sizes to achieve optimum sorting and consolidation efficiency for fulfilling an order request for an item or multiple items. Each operation station 210 may facilitate various requisite operations such as splitting, segregation, and/or consolidation. Consequently, the order consolidation system 112 facilitates various operations required for order consolidation within a setup that has a relatively small physical footprint. The order consolidation system 112 acts as a closed system that constitutes an end-to-end solution for order consolidation, iteratively performing the various operations to achieve nₜₕ level sortation.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. An order consolidation method, comprising:
receiving, by a control circuitry of an order consolidation system, a plurality of order requests, wherein each of the plurality of order requests includes one or more order lines for one or more items, respectively;
identifying, by the control circuitry, a set of order lines for a first item based on the plurality of order requests;
selecting, by the control circuitry, a set of master packages of the first item for fulfilling the set of order lines, wherein each of the set of order lines is indicative of an order quantity for the first item, and wherein the set of master packages is selected based on a cumulative order quantity of the set of order lines and a count of units included in each master package of the first item;
identifying, by the control circuitry, one or more master packages of the set of master packages that are to be split at unit level to fulfil the set of order lines;
selecting, by an identification mechanism of the order consolidation system, a first bin of an operation station of the order consolidation system as a segregation bin and a second bin of the operation station as a consolidation bin, wherein the first bin is selected as the segregation bin for splitting the one or more master packages at the unit level;
controlling, by the control circuitry, a conveying mechanism of the order consolidation system, to convey the one or more master packages from the identification mechanism to the first bin and remaining master packages of the set of master packages from the identification mechanism to the second bin, wherein, at the first bin, the one or more master packages are split at the unit level to obtain a plurality of units of the first item and the plurality of units are segregated to obtain one or more batches of the first item for one or more order lines of the set of order lines;
controlling, by the control circuitry, the conveying mechanism, to convey the one or more batches to the second bin; and
instructing, by the control circuitry, a handler, at the second bin, to consolidate the one or more batches and the remaining master packages received at the second bin based on the order quantity of each of the set of order lines, to obtain a set of order line packages for fulfilling the set of order lines.

2. The order consolidation method of claim 1, wherein a difference between a count of units included in the set of master packages and the cumulative order quantity is less than the count of units included in each master package of the first item.

3. The order consolidation method of claim 1, wherein the one or more master packages are identified based on the order quantity of each of the set of order lines and the count of units in each of the set of master packages.

4. The order consolidation method of claim 1, further comprising receiving, by an in-feed station of the order consolidation system, the set of master packages from an inbound storage area.

5. The order consolidation method of claim 4, further comprising determining, by a dimensioning and weighing mechanism of the order consolidation system, a set of dimensions and a weight of each master package received by the in-feed station.

6. The order consolidation method of claim 5, further comprising:
rejecting, by the control circuitry, a first master package of the set of master packages based on a mismatch between the set of dimensions and the weight of the first master package and a pre-determined set of dimensions and a pre-determined weight, respectively; and
selecting, by the control circuitry, a new master package of the first item to replace the rejected first master package in the set of master packages.

7. The order consolidation method of claim 1, further comprising applying, by a labeling mechanism of the order consolidation system, a physical label on each of the one or more batches, wherein the physical label on each of the one or more batches is indicative of one or more details of a corresponding batch.

8. The order consolidation method of claim 1, wherein each of the one or more batches includes one or more units of the first item.

9. The order consolidation method of claim 1, wherein the one or more master packages, the remaining master packages of the set of master packages, and the one or more batches are conveyed by way of a set of autonomous guided vehicles of the conveying mechanism.

10. The order consolidation method of claim 1, wherein the conveying mechanism includes at least one of a set of conveyors and a set of transportation vehicles.

11. An order consolidation system, comprising:
at least one operation station including a plurality of bins;
an identification mechanism configured to select a first bin of the plurality of bins as a segregation bin and a second bin of the plurality of bins as a consolidation bin;
a conveying mechanism; and
control circuitry configured to:
receive a plurality of order requests, wherein each of the plurality of order requests includes one or more order lines for one or more items, respectively,
identify a set of order lines for a first item based on the plurality of order requests;
select a set of master packages of the first item for fulfilling the set of order lines, wherein each of the set of order lines is indicative of an order quantity for the first item, and wherein the set of master packages is selected based on a cumulative order quantity of the set of order lines and a count of units included in each master package of the first item,
identify one or more master packages of the set of master packages that are to be split at unit level to fulfil the set of order lines,
control the conveying mechanism to convey the one or more master packages from the identification mechanism to the first bin and remaining master packages of the set of master packages from the identification mechanism to the second bin, wherein, at the first bin, the one or more master packages are split at the unit level to obtain a plurality of units of the first item and the plurality of units are segregated to obtain one or more batches of the first item for one or more order lines of the set of order lines,
control the conveying mechanism to convey the one or more batches to the second bin, and
instruct a handler at the second bin to consolidate the one or more batches and the remaining master packages received at the second bin based on the order quantity of each of the set of order lines, to obtain a set of order line packages for fulfilling the set of order lines.

12. The order consolidation system of claim 11, wherein a difference between a count of units included in the set of master packages and the cumulative order quantity is less than the count of units included in each master package of the first item.

13. The order consolidation system of claim 11, wherein the one or more master packages are identified based on the order quantity of each of the set of order lines and the count of units in each of the set of master packages.

14. The order consolidation system of claim 11, further comprising at least one in-feed station that is configured to receive the set of master packages from an inbound storage area and the one or more batches from the first bin.

15. The order consolidation system of claim 14, further comprising a dimensioning and weighing mechanism (DWM) that is configured to determine a set of dimensions and a weight of each master package received by the at least one in-feed station.

16. The order consolidation system of claim 15, wherein the control circuitry is further configured to:
reject a first master package of the set of master packages based on a mismatch between the set of dimensions and the weight of the first master package and a pre-determined set of dimensions and a pre-determined weight, respectively; and
select a new master package of the first item to replace the rejected first master package in the set of master packages.

17. The order consolidation system of claim 11, further comprising a labeling mechanism that is configured to apply a physical label on each of the one or more batches, wherein the physical label on each of the one or more batches is indicative of one or more details of a corresponding batch.

18. The order consolidation system of claim 11, wherein each of the one or more batches includes one or more units of the first item.

19. The order consolidation system of claim 11, wherein the conveying mechanism comprises a set of autonomous guided vehicles (AGVs) that is configured to convey the one or more master packages, the remaining master packages of the set of master packages, and the one or more batches.

20. The order consolidation system of claim 11, wherein the conveying mechanism comprises at least one of a set of conveyors and a set of transportation vehicles.
